(19) United States
(12) Patent Application Publication
(10) Pub. No.: US 2025/0227607 A1
(43) Pub. Date: Jul. 10, 2025

(54) SYSTEM AND METHOD FOR CONNECTING TO A UBIQUITOUS WIRELESS NETWORK

(71) Applicant: 5321 Innovation Labs LLC, Franklin, MA (US)

(72) Inventors: Edward W. Neipris, Wrentham, MA (US); Russell Daniel Whitney, Whitinsville, MA (US); Mikenzie Reeder Wade, Castle Rock, CO (US); Tyler Richard Nesper, Denver, CO (US)

(21) Appl. No.: 19/013,154

(22) Filed: Jan. 8, 2025

Related U.S. Application Data
(60) Provisional application No. 63/618,418, filed on Jan. 8, 2024.

(51) Int. Cl. H04W 48/20

(52) U.S. Cl. CPC H04W 48/20

(57) ABSTRACT

A system and method for connecting a wireless device to a ubiquitous wireless network in which the ubiquitous network determines if the wireless device should be bound to a selection of access points for network connection. The ubiquitous network maintains a lookup table that links the Media Access Control (MAC) address of each wireless device with a selection of the most appropriate access points through which network connectivity is to be established. Accordingly, when each wireless device sends a probe request in an attempt to connect to the ubiquitous network, only the specified access points are configured to handle the response. In this manner, a high-quality network connection can be maintained. However, if no bound access points are available and within range to handle the response, a non-bound access point may temporarily provide a response to the probe request to ensure that some level of network connectivity is maintained.

### CROSS-REFERENCE TO RELATED APPLICATIONS

The present invention claims the benefit under 35 U.S.C. 119(e) to U.S. Provisional Patent Application No. 63/618,418, which was filed on Jan. 8, 2024, in the names of Edward W. Neipris et al., the disclosure of which is incorporated herein by reference.

### FIELD OF THE INVENTION

The present invention relates generally to the field of wireless networks and, more particularly, to methods for connecting to ubiquitous wireless networks.

### BACKGROUND OF THE INVENTION

A ubiquitous wireless network, or ubiquitous network, is an advanced wireless network that supports seamless, reliable, and uninterrupted network connectivity across an expansive physical environment. Ubiquitous wireless networks are prevalent in a wide range of settings that require consistent connectivity as a device travels throughout a defined geographic area, such as, but not limited to, a hotel, an apartment complex, an educational campus, a business office, or even a single-family residence.

Typically, a ubiquitous network includes a plurality of interconnected wireless access points (WAPs), or access points (APs), in communication with various network services (e.g., internet access) and network devices (e.g., network printers). Each access point is responsible for, inter alia, broadcasting the network connectivity options and, in turn, regulating network access to wirelessly enabled devices within its geographic range. To increase network range in larger physical environments, a multitude of access points are typically utilized and physically arranged in an optimized configuration.

Traditionally, a verified wireless device is allowed to connect to any access point within a ubiquitous wireless network in order to gain access to certain network resources. Ubiquitous networks rely upon the wireless device to select the specific access point through which network connectivity is to be established, with the device switching APs, as needed, to maintain adequate connectivity and thereby minimize signal disruptions. Commonly, each wireless device is configured to select an access point based on a set of predefined connection parameters, such as signal strength, connection speed, or order of signal reception. However, it should be noted that these connection parameters often utilize a relatively low threshold in order to ensure that at least one access point within range is available to the device as a connection point.

Because the wireless device selects an access point for network connectivity based on certain basic connection parameters, it has been found that the wireless device often renders an inferior connection point selection. As a result, the quality of the network connection established by the wireless device may be suboptimal in certain circumstances.

For instance, a wireless device may select an access point for connection simply because a certain access point was first to respond to the initial connection request. Although the selected AP would comply with the minimum connection requirements, another access point may have provided the device with a significantly higher quality connection.

Notably, in certain settings, it is often preferable for a wireless device to select an access point that is closest in proximity in order to optimize performance. For a ubiquitous network installed in an apartment complex, a relatively non-mobile, high-performance wireless device, such as a smart, or connected, television, would benefit by connecting to an access point located within the same apartment unit as opposed to an access point located within range but in a neighboring unit.

Additionally, a network administrator may apply specific upstream configurations to specific access points within a ubiquitous wireless network that include, among other things, Quality of Service (QOS) tags, routing rules, or access control rules. Ideally, the network administrator would prefer that these APs provide network connectivity for devices of a certain class or type, such as phones, printers, or point-of-sale devices, while enabling other wirelessly enabled devices to roam freely within the network.

### SUMMARY OF THE INVENTION

In view thereof, it is an object of the present invention to provide a novel system and method for connecting to a ubiquitous wireless network.

It is another object of the present invention to provide a system and method of the type as described above wherein connectivity established with the ubiquitous wireless network is seamless, reliable, and uninterrupted.

It is yet another object of the present invention to provide a system and method of the type as described above wherein the quality of connection maintained with the ubiquitous wireless network is optimized for enhanced device performance.

It is still another object of the present invention to provide a system and method of the type as described above which is inexpensive to implement and readily scalable.

Accordingly, as one feature of the present invention, there is provided a wireless network connection system comprising (a) a ubiquitous wireless network comprising (i) one or more network resources, (ii) a plurality of access points in communication with the one or more network resources, and (iii) a database in communication with each of the plurality of access points, the database maintaining a lookup table, and (b) an electronic device seeking connection with the ubiquitous wireless network, the electronic device having an identifier, (c) wherein the lookup table cross-references the identifier for the electronic device with a selection of the plurality of access points, (d) wherein network access to the ubiquitous wireless network by the electronic device is restricted to the selection of the plurality of access points associated with the identifier for the electronic device in the lookup table.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified block diagram of a system for connecting to a ubiquitous wireless network, the system being designed according to the teachings of the present invention; and

FIG. 2 is a flow chart depicting a novel process for connecting a wireless device to a ubiquitous wireless network using the system shown in FIG. 1.

### DETAILED DESCRIPTION OF THE INVENTION

### Wireless Network Connection System 11

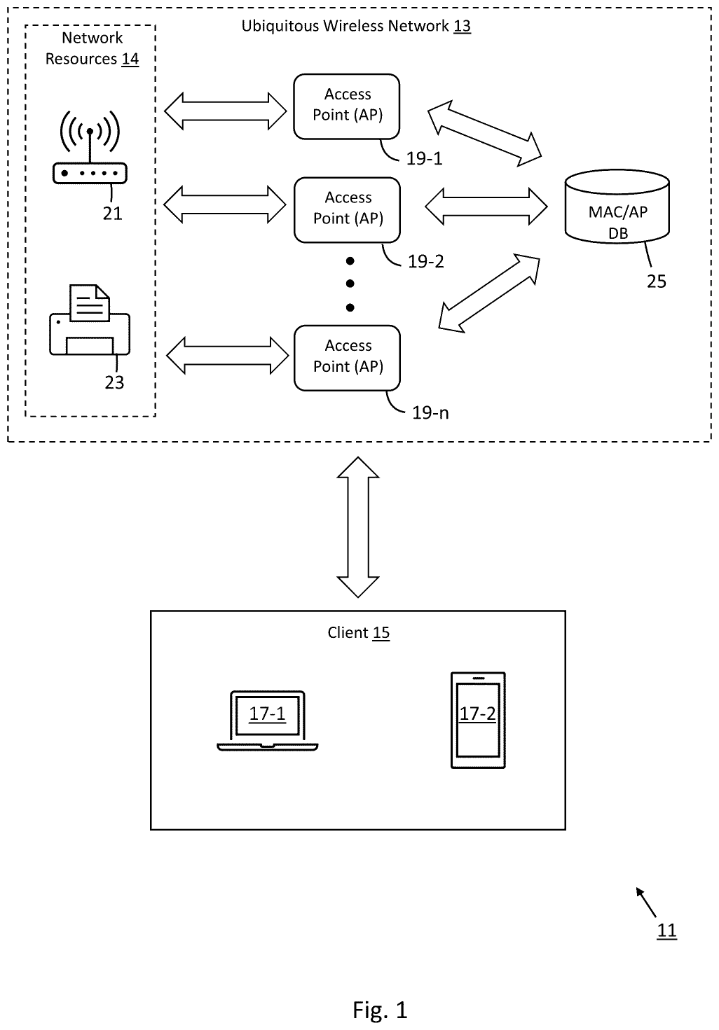

Referring now to FIG. 1, there is shown the basic architecture of a system for connecting to a ubiquitous wireless network, the system being designed according to the teachings of the present invention and identified generally by reference numeral 11. As will be explained in detail below, system 11 is uniquely configured with connection rules that bind, or restrict, each electronic device seeking connection to a ubiquitous wireless network to a specific selection of access points. By binding each wireless devices to a certain selection of available access points, high-quality network connectivity can be maintained, thereby ensuring optimal equipment performance.

As can be seen, system 11 comprises (i) a ubiquitous wireless network 13 that provides selective access to various network resources 14, and (ii) at least one user, or client, 15 seeking access to ubiquitous wireless network 13. As will be described further in detail below, ubiquitous wireless network 13 is designed to provide seamless, uninterrupted network connectivity as client 15 roams throughout a relatively expansive geographic area, while utilizing the most appropriate connection path. In this manner, client 15 is afforded a network connection that is both reliable and high performing.

For simplicity and ease of illustration, system 11 is shown depicting a single client 15 seeking connection to ubiquitous wireless network 13. However, it is to be understood that, in actuality, system 11 would typically include a plurality of users 15 seeking connection to ubiquitous wireless network 13, often within the same period of time.

Additionally, in the present embodiment, client 15 is shown comprising a pair of electronic devices, or user equipment (UE), 17-1 and 17-2. Each UE 17 represents any wirelessly enabled electronic device. For instance, UE 17-1 is depicted herein as a laptop computer and UE 17-2 is depicted herein as a smartphone. However, it to be understood that the number and/or type of user equipment 17 could be modified without departing from the spirit of the present invention.

As can be appreciated, the specific design and means of user connectivity implemented by ubiquitous wireless network 13 are considered novel. Most notably, ubiquitous wireless network 13 is uniquely configured to bind each electronic device 17 seeking network connection to one or more designated connection points. This connection point binding process runs in direct contrast to conventional ubiquitous networks, which typically rely upon each electronic device 17 to select a suitable path for network connection. By transferring the connection point selection process from each individual electronic device 17 to ubiquitous wireless network 13, a higher quality network connection standard can be ensured, which is a principal object of the present invention.

### Ubiquitous Wireless Network 13

As referenced above, ubiquitous wireless network 13 is an advanced wireless network that supports seamless, reliable, and uninterrupted network connectivity across an expansive physical environment. As a primary feature of the present invention, ubiquitous wireless network 13 is uniquely configured to bind, or restrict, each electronic device 17 seeking network connection to a selection of designated connection points. As a result, the quality of connection to network 13 can be maintained at an optimal level.

As seen in FIG. 1, ubiquitous wireless network 13 is similar in design to a conventional wireless network in that ubiquitous wireless network 13 comprises (i) a variety of network resources 14, and (ii) a plurality of wireless access points (WAPs), or access points (APs), 19-1 thru 19-n in communication with network resources 14. As can be appreciated, network resources 14 are delivered to authorized users 15 via access points 19.

Network resources 14 is represented herein as comprising (i) a variety of network services, such as internet services provided via router 21, and (ii) a variety of network devices, such as a network printer 23. Together, network resources 14 and access points 19 are responsible for, inter alia, establishing ubiquitous wireless network 13, maintaining a service set identifier (SSID) as a means for network identification by each client 15 within range, and defining the capabilities of the network SSID (e.g., the connection type, authentication method, and encryption method for the network).

Each access point 19 is a network device that enables authenticated electronic devices 17 to connect to network 13 and, in turn, utilize available network devices and services. In the present embodiment, a plurality of interconnected access points 19 is utilized and configured to broaden the range of network 13 and thereby ensure reliable network connectivity. As needed, additional access points 19 could be readily integrated into network 13 to further expand the scope of network 13 and thereby support even larger network coverage.

Ubiquitous wireless network 13 differs from a conventional ubiquitous network in that ubiquitous wireless network 13 maintains a database 25 in communication with each access point 21. As will be explained further below, database 25 compiles and maintains a lookup table that links an identifier associated with each piece of user equipment 17 with a selection of access points 19 through which network connectivity is preferably to be restricted.

In the description that follows, the preassigned Media Access Control (MAC) address is utilized as the identifier for each piece of user equipment 17. However, it should be noted that the present invention is not limited to the use of a MAC address as a means for identifying each piece of user equipment 17. Rather, it is to be understood that alternative types of identifiers could be used in place thereof without departing from the spirit of the present invention. For example, additional device identifiers may include, inter alia, a set of authentication credentials, a device name, or a device type.

### Network Connection Process 111

As referenced above, system 11 is uniquely designed to implement a novel process for connecting to ubiquitous wireless network 13, the process being identified generally herein using reference numeral 111. As will be explained in detail below, process 111 restricts, or binds, connection to ubiquitous wireless network 13 by a wireless device 17 to the most appropriate, or optimal, set of access points 19. As a result, method 111 ensures that each wireless device 17 maintains a reliable, high-quality connection to network 13 while roaming throughout a sizable physical environment.

As an additional feature of the present invention, process 111 may enable a wireless device 17 to connect to ubiquitous wireless network 13 even when not in range of its specifically bound APs. In this scenario, the wireless device 17 is afforded temporary access to wireless network 13 via non-bound APs until such time that a bound, or selected, AP is within range. As a result, continuous and reliable connectivity is maintained.

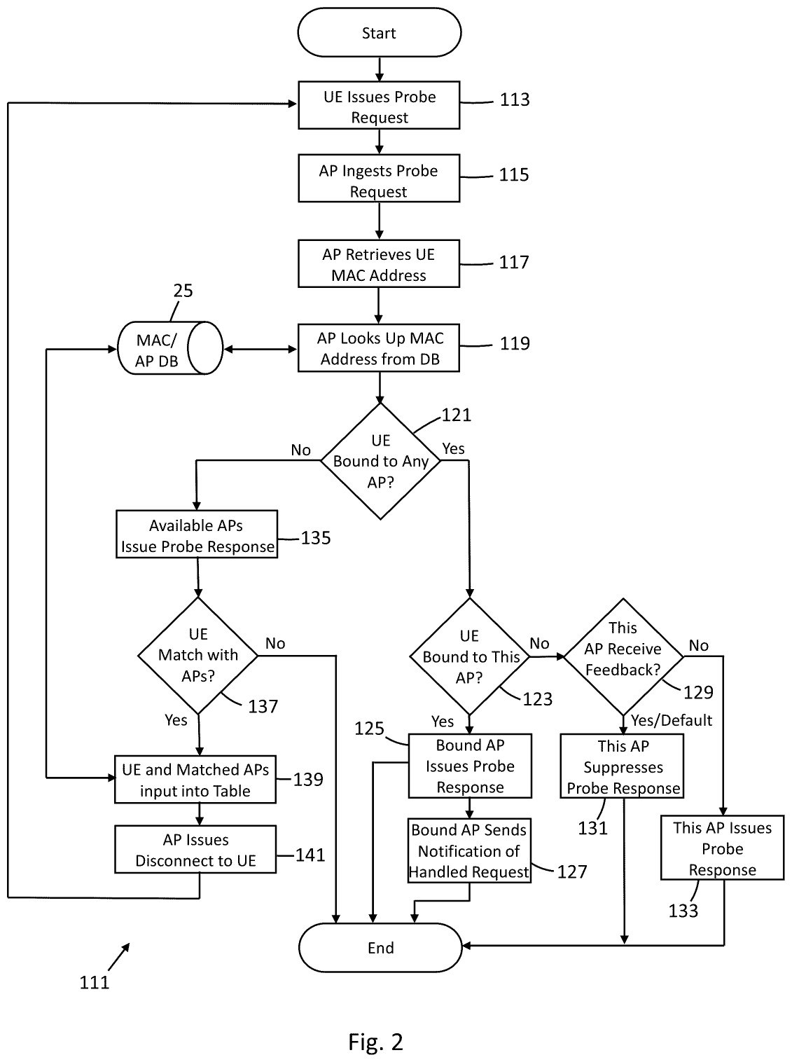

Referring now to FIG. 2, there is shown a simplified flow chart of network connection process, or method, 111. As can be seen, when attempting to connect to wireless network 13, user equipment 17 first issues a probe, or connection, request, the probe request being represented generally as step 113 in FIG. 2.

The probe request sent by user equipment 17 is a broadcast message sent to all available APs 19 within listening distance. As part of step 113, user equipment 17 requests that each AP 19 return values indicating the connectivity options available through the particular AP 19. Additionally, user equipment 17 requests each access point 19 provide the capabilities of each connection option, such as, but not limited to, the network connection type, the method of user authentication, and the active protocol of wireless encryption.

Upon receiving the probe request, an access point 19 capable of providing network connection ingests the probe request, as shown in step 115. Thereafter, access point 19 attempts to retrieve the Media Access Control (MAC) address from the specific piece of user equipment 17, the MAC address retrieval step being represented generally by reference numeral 117 in FIG. 2.

Having received the MAC address from user equipment 17, access point 19 performs a lookup of the MAC address for user equipment 17 in the MAC/AP lookup table maintained by database 25, as represented generally by step 119 in FIG. 2. Lookup step 119 can be performed using various techniques including, but not limited to, a direct database lookup, an Application Programming Interface (API) request, or a Remote Authentication Dial-In User Service (RADIUS) access request.

As part of step 121, access point 19 determines whether the MAC address for the user equipment 17 is currently bound to any selection of access points 19. In other words, access point 19 determines whether user equipment 17 previously engaged in the connection point binding process in order to connect to ubiquitous wireless network 13.

If the piece of user equipment 17 has one or more access points 19 already associated with its MAC address in MAC/AP database 25, each access point 19 within range will determine whether it is one of the APs that is specifically bound to the user equipment 17, as represented by determining step 123. If an access point 19 is a bound AP 19, it will issue a response to the probe request, as represented by response step 125. Upon receiving responses from bound access points 19, wireless device 17 will connect to ubiquitous wireless network 13 through one of the bound APs 19 (e.g., the first bound AP 19 to respond).

As an optional step, the AP 19 through which the wireless device 17 establishes network connectivity may provide a feedback mechanism to the other APs 19 that the initial probe request has been seen and handled, this notification step being represented generally by reference numeral 127. As a result, the other APs 19 are notified that the probe request was suitably handled and that the wireless device 17 has received connectivity guidance.

If an access point is not a bound AP 19 (i.e., an AP 19 not linked with the MAC address of the user device 17), the non-bound AP 19 will determine whether it has received feedback from a bound AP 19 that the user probe request has been satisfied, this determination step being represented generally by reference numeral 129 in FIG. 2. If feedback has been received, the non-bound AP 19 suppresses its probe response, as represented by suppression step 131. In other words, non-bound APs 19 render themselves unavailable as network connection points for the wireless device 17.

However, if feedback has not been received in step 129, any non-bound AP 19 within range of the initial probe request may presume that user equipment 17 was not able to connect to ubiquitous wireless network 13 (e.g., because the wireless enabled device 17 was not within range of any bound APs 19 or bound APs 19 were experiencing technical problems). In this case, non-bound APs 19 may elect to issue a response to the initial probe request, as represented by response step 133. Accordingly, a non-bound AP 19 may serve as a temporary connection point for the wireless device 17. Although a non-bound AP may not provide an ideal, or most appropriate, connection point, it ensures that at least some network connectivity is available to user 15.

Returning back to determining step 121, if the piece of user equipment 17 does not have an access point 19 associated with its MAC address in MAC/AP database 25 (e.g., due to no previous attempt to connect to network 13), all access points 19 within range that heard the initial probe request will issue a probe response to user equipment 17, as represented by response step 135 in FIG. 2. In response, user equipment 17 selects an access point 19 through which connection to ubiquitous wireless network 13 is established.

Thereafter, as part of step 137, a determination is made whether user equipment 17 should be bound to a specific selection of access points 19. The checks, or parameters, for determining whether to bind the wireless device 17 to one or more specific APs 19 could include, but are not limited to, the credentials used to connect to ubiquitous network 13, the type of device seeking network connection, or other related connection-based parameters. For instance, wireless network 13 may elect to bind all electronic devices 17 associated with a single client 15 to the same selection of APs 19 (e.g., by recognizing a common pre-shared key (PSK) or other similar unique connection parameter associated with user 15).

If AP binding is not required for the wireless device 17, network connection is maintained with the active AP 19 and process 111 terminates. However, if it is determined that the wireless device 17 should be bound to one or more specific access points 19, the MAC address of UE 17 and the identified APs 19 are linked together and input into the lookup data table maintained by MAC/AP database 25, this recordation step being represented generally by reference numeral 139. This entry into the lookup table could be created by, inter alia, a direct table update, an API request, or a manual entry into the lookup data table.

As a result of step 139, any future lookup required by the wireless device 17 as part of probe request step 113 will issue notification that the MAC address of the connecting device 17 has been found in the lookup table maintained in MAC/AP database 25 and that the connecting device 17 is bound to a specific set of access points 19.

Following recordation step 139, the active access point 19 disconnects user equipment 17 from network 13 as part of a disconnection step 141. Preferably, notification of disconnection can be delivered by, but not limited to, a change of authority message or a device disconnect message. Once the disconnect notification is received, the active AP 19 disconnects the wireless device 17.

After the access point 21 issues the disconnect to wireless device 17, connection process 111 returns to probe request step 113, as shown in FIG. 2. This time, however, when access point 19 performs lookup step 119 to determine whether the MAC address of UE 17 is bound to a selection of APs 19, it will identify that one or more APs 19 are already associated with the MAC address. Therefore, bound APs 19 will issue a probe response, as part of step 125, and non-bound APs 19 will suppress a probe response, as part of step 131. As an exception to the aforementioned response, non-bound APs 19 may elect to issue a response to the initial probe request if no bound APs 19 provide notification that the connection request was handled, as represented in step 133.

As a feature of the present invention, the aforementioned process ensures that an electronic device seeking connection to a ubiquitous wireless network utilizes the most appropriate APs 19 as network connection points, thereby optimizing the quality of network connection. At the same time, inferior APs 19 may serve as temporary connection points, when needed, to maintain some level of network connectivity. Accordingly, method 111 provides a wireless device with connectivity to a ubiquitous wireless network that is both reliable and of the highest possible quality.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

As set forth in detail above, the present invention is uniquely designed to bind an electronic device seeking connection to a wireless network to one or more designated access points. This principle of binding access to a wireless network through one or more designated APs could be similarly applied in other types of wireless networks without departing from the spirit of the present invention.

As an example, it is to be understood that ubiquitous wireless network 13 could be designed with a single access point 19 through which connection to network 13 can be obtained. In this capacity, the single access point 19 may serve to restrict access to wireless network 13 to only those bound electronic devices 17 listed in database 25. By contrast, unauthorized wireless devices 17 would be effectively restricted from any access to network 13.

As another example, it is to be understood that wireless network 13 may be configured with only a selection of the plurality of access points 19 in communication with MAC/AP database 25. As such, the APs 19 in communication with MAC/AP database 25 would restrict network access to only those bound devices 17 listed in database 25. The remainder of the plurality of access points 19 may apply more general connection rules, such as unrestricted network access to all wireless devices 17 within its wireless range.

What is claimed is:

1. A wireless network connection system comprising:
(a) a ubiquitous wireless network comprising,
(i) one or more network resources,
(ii) a plurality of access points in communication with the one or more network resources, and
(iii) a database in communication with each of the plurality of access points, the database maintaining a lookup table; and
(b) an electronic device seeking connection with the ubiquitous wireless network, the electronic device having an identifier;
(c) wherein the lookup table cross-references the identifier for the electronic device with a selection of the plurality of access points;
(d) wherein network access to the ubiquitous wireless network by the electronic device is restricted to the selection of the plurality of access points associated with the identifier for the electronic device in the lookup table.

2. The system as claimed in claim 1 wherein the ubiquitous wireless network is configured to automatically retrieve the identifier from the electronic device.

3. The system as claimed in claim 2 wherein the identifier is based on at least one of a set of authentication credentials, a device name, and a device type.

4. The system as claimed in claim 2 wherein the identifier is unique to the electronic device.

5. The system as claimed in claim 4 wherein the identifier is in the form of a unique Media Access Control (MAC) address.

6. The system as claimed in claim 2 wherein the wireless device transmits a connection request to the ubiquitous wireless network when attempting to gain network access.

7. The system as claimed in claim 6 wherein the one of the plurality access points that handles the connection request issues a notification to the remainder of the plurality of access points that the connection request has been handled.

8. The system as claimed in claim 7 wherein, if a notification that the connection request has been handled is not received by the plurality of access points, access to the ubiquitous wireless network is provided to the wireless device via one of the plurality of access points that is not cross-referenced with the identifier for the wireless device in the lookup table.

9. The system as claimed in claim 2 wherein network resources comprise network services.

10. The system as claimed in claim 9 wherein network services comprise internet services.

11. The system as claimed in claim 2 wherein network resources comprise network devices.

12. The system as claimed in claim 11 wherein network devices comprise network printers.

13. The system as claimed in claim 2 wherein the selection of the plurality of access points cross-referenced with the identifier for the wireless device is retrieved from the lookup table using one of a direct database lookup, an Application Programming Interface (API) request, and a Remote Authentication Dial-In User Service (RADIUS) access request.
